(19) United States
(12) Patent Application Publication
(10) Pub. No.: US 2009/0021262 A1
(43) Pub. Date: Jan. 22, 2009

(54) Non Polarized Contacts for Resistivity Measurements in Drill Cuttings Samples for Surface Logging While Drilling

(76) Inventor: Konstandinos Zamfes, Calgary (CA)

Correspondence Address: DIEDERIKS & WHITELAW, PLC, 12471 DILLINGHAM SQUARE, #301, WOODBRIDGE, VA, 22192, US

(21) Appl. No.: 12/144,024

(22) Filed: Jun. 23, 2008

Related U.S. Application Data
(60) Provisional application No. 60/929,348, filed on Jun. 22, 2007.

(51) Int. Cl. G01V 3/20

(52) U.S. Cl. 324/356

(57) ABSTRACT

Apparatus and probe for non-polarized contacts for resistivity measurements in drill cuttings. At least two probes having a highly conductive shell from non-corrosive metal in form of pipe and a wood and/or other fine channeled thread (grained) water filled that will be conductive when it is wet.

### CROSS REFERENCE TO RELATED APPLICATIONS

This application claims the benefit of priority of U.S. Provisional Patent Application No. 60/929,348 filed Jun. 22, 2007, which is incorporated herein by reference in its entirety.

### FIELD OF THE INVENTION

The present invention relates generally to resistivity measurement. More particularly, the present invention relates to a probe for resistivity measurement in drill cuttings.

### BACKGROUND OF THE INVENTION

During the measurement of contact resistivity in rocks, rock cuttings or soil, the polarization of the electrodes is a problem that affects the measurements and the value of the resistivity and causes corrosion of the electrodes which in turn changes the precision of the measurements.

One application where resistivity may be measured is the drilling of a well. During the drilling of a well, mud is circulated downhole to carry away drill cuttings. The cuttings are a view into the characteristics of the drilled strata. In an active mud system, the mud is circulated in a loop; pumped from the mud tank, downhole to the drilling bit, up the annulus to the surface, and back to the mud tank for separation of cuttings, and separation of fine solids in tanks, reconstitution of mud ingredients and reuse. The cuttings may be sampled and discarded in a sump. The sampling of the cuttings enables the driller to review the strata being drilled. One such sample includes a determination or measurement of the resistivity.

Analysis or measurements taken on the drill cuttings returned to surface may be referred to as surface logging while drilling (SLWD).

It is, therefore, desirable to provide non-polarized contacts for resistivity measurement.

### SUMMARY OF THE INVENTION

It is an object of the present invention to obviate or mitigate at least one disadvantage of previous methods and apparatus for resistivity measurement.

In a first aspect, the present invention provides an apparatus for resistivity measurement of drill cuttings, including a container adapted to contain an amount of drill cuttings, a first probe, adapted to introduce electrical energy into the drill cuttings, the first probe having a conductive shell; a porous insert within the conductive shell, and a contact within the porous insert, a second probe, adapted to receive electrical energy from the drill cuttings; the second probe having a conductive shell; a porous insert within the conductive shell, the porous insert adapted to retain a liquid solution, and a contact within the porous insert, a power source, adapted to provide the electrical energy, and measurement means, adapted to measure the flow of the electrical energy.

In one embodiment, the second probe is longitudinally spaced from the first probe. In one embodiment, the conductive shell is made of a highly conductive metal, for example copper, silver, brass, stainless steel, or combinations or alloys thereof.

In one embodiment, the porous insert includes a fine channeled material capable of liquid fill. In one embodiment, the porous insert is wood, for example a hardwood, oak, or pine.

In one embodiment, the contact is a highly conductive material, for example brass, copper, or combinations or alloys thereof. In one embodiment, the contact is a corrosion resistant material, for example a copper-brass alloy.

In one embodiment, the liquid solution includes water. In one embodiment, the liquid solution includes copper (II) hydroxide (chemical formula Cu(OH)2).

In one embodiment, the first probe and/or second probe adapted to receive an electrical current to reduce electrical corrosion.

In a further aspect, the present invention provides a probe for resistivity measurement, including a conductive shell, a porous insert within the conductive shell, the porous insert adapted to retain a liquid solution, and a contact within the porous insert, the probe adapted to introduce and/or receive electrical energy from a sample.

In one embodiment the conductive shell is made of a highly conductive metal, for example copper, silver, brass, stainless steel, or combinations or alloys thereof.

In one embodiment the porous insert includes a fine channeled material capable of liquid fill. In one embodiment the porous insert is wood, for example a hardwood, oak, or pine.

In one embodiment the contact is a highly conductive material, for example brass, copper, or combinations or alloys thereof.

Other aspects and features of the present invention will become apparent to those ordinarily skilled in the art upon review of the following description of specific embodiments of the invention in conjunction with the accompanying FIGURE.

### BRIEF DESCRIPTION OF THE DRAWINGS

Embodiments of the present invention will now be described, by way of example only, with reference to the attached FIGURE, wherein:

FIG. 1 is a non-polarized contacts for resistivity measurements in cutting samples for SLWD of the present invention.

### DETAILED DESCRIPTION

Generally, the present invention provides a method and system for assessing or measuring the resistivity of a sample.

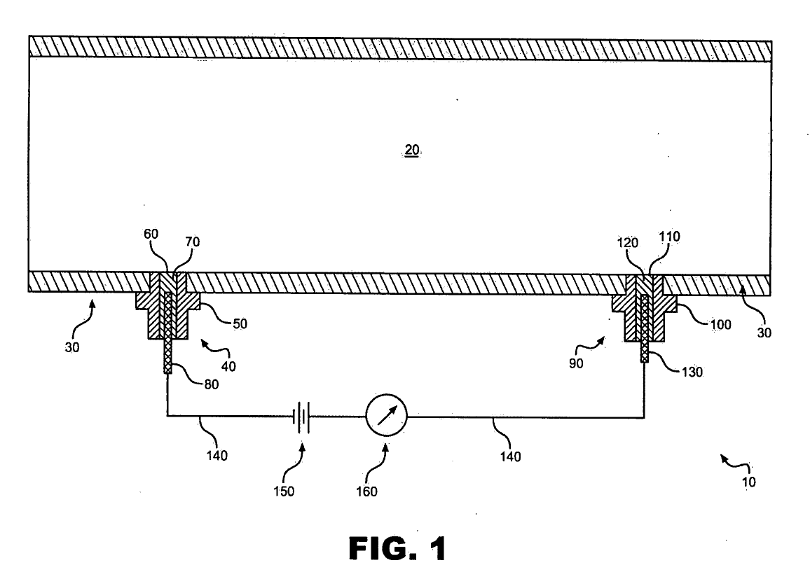

Referring to FIG. 1, the apparatus 10 receives a sample 20, for example within a sample container 30, such as a pipe. The sample container 30 is substantially non-conducting. The sample container 30, while shown in a substantially horizontal orientation, may also operate in a substantially vertical orientation or an angle.

While shown as a flowing, or semi-continuous flowing sample 20, the present invention is also suitable for a static, or non-flowing sample 20.

A first probe 40 is adapted to introduce a current into the sample 20. The first probe 40 has a conductive shell 50, and a porous insert 60 within the conductive shell 50. The porous insert 60 is adapted to retain a liquid solution 70. A contact 80 is received in the porous insert 60.

A second probe 90 is adapted to receive a current from the sample 20. The second probe 90 has a conductive shell 100, and a porous insert 110 within the conductive shell 100. The porous insert 110 is adapted to retain a liquid solution 120. A contact 130 is received in the porous insert 110.

The conductive shell 50 and/or the conductive shell 100 are preferably made of a highly conductive metal. Preferably, the highly conductive metal is copper, silver, brass, stainless steel, or combinations thereof or alloys thereof.

The porous insert 60 and/or the porous insert 110 is preferably a fine channeled material capable of liquid fill. Preferably the porous insert 60 and/or the porous insert 110 comprise wood. Preferably, the wood is a hardwood, oak, or pine.

The contact 80 and/or the contact 130 is preferably a highly conductive material, for example brass, copper, or combinations or alloys thereof. The contact 80 and/or the contact 130 is preferably a corrosion resistant material, for example a copper-brass alloy.

The liquid solution 70 and/or the liquid solution 120 are preferably copper (II) hydroxide (chemical formula Cu(OH)₂). The liquid solution 70 and/or the liquid solution 120 may be water, such as potable water, usually containing some salt or salts which improve conductivity. A salt, such as copper (II) hydroxide, may be added to sweet water (having a low resistivity and substantially no salt) or distilled water. However, normal potable or tap water or water experienced in drilling cuttings usually provides sufficient conductivity, as one skilled in the art will recognize. In one embodiment, the porous insert 60 and the porous insert 110 are self wetting, as the liquid solution 780 and the liquid solution 120 are provided or maintained by fluids in the sample 20, for example water and otherwise from drilling cuttings.

A electrical conductor 140 connects the first probe 40 and the second probe 90. A circuit is completed between the first probe 40 and the second probe 90 through the sample 20, thus providing a resistivity analysis or measurement of the sample 20 between the first probe 40 and the second probe 90.

A power source 150 provides electrical power (volts and/or amps), either AC or DC. Preferably, the power source 150 provides a square wave pulse. The square wave pulse helps break or reduce localized polarity.

A measurement means 160 measures or detects the electrical power (volts and/or amps) flowing through the circuit. Preferably the measurement means 160 measures the current flow. Preferably the measurement means 160 measures the current flow over time, which can then be correlated with the sample 20. One skilled in the art is able to determine the resistivity of the sample 20 from the current measurement, mass/volume of material between the probes, distance between the probes etc.

In operation, the power source 150 provides electrical power which is delivered to the first probe 40 and into the sample 20. The power flows through the sample 20 and from the second probe 90. The measurement means 160 provides a measurement of the electrical power flow.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. An apparatus for resistivity measurement of drill cuttings, comprising:
a. a container adapted to contain an amount of drill cuttings;
b. a first probe, adapted to introduce electrical energy into the drill cuttings, the first probe having a conductive shell; a porous insert within the conductive shell, and a contact within the porous insert;
c. a second probe, adapted to receive electrical energy from the drill cuttings; the second probe having a conductive shell; a porous insert within the conductive shell, the porous insert adapted to retain a liquid solution, and a contact within the porous insert;
d. a power source, adapted to provide the electrical energy; and
e. measurement means, adapted to measure the flow of the electrical energy.

2. The apparatus of claim 1, the second probe longitudinally spaced from the first probe.

3. The apparatus of claim 1, the conductive shell made of a highly conductive metal.

4. The apparatus of claim 3, the highly conductive metal comprising copper, silver, brass, stainless steel, or combinations or alloys thereof.

5. The apparatus of claim 1, the porous insert comprising a fine channeled material capable of liquid fill.

6. The apparatus of claim 1, the porous insert comprising wood.

7. The apparatus of claim 6, the wood comprising a hardwood, oak, or pine.

8. The apparatus of claim 1, the contact comprising a highly conductive material.

9. The apparatus of claim 8, the highly conductive material comprising brass, copper, or combinations or alloys thereof.

10. The apparatus of claim 1, the contact comprising a corrosion resistant material.

11. The apparatus of claim 9, the corrosion resistant material comprising a copper-brass alloy.

12. The apparatus of claim 1, the liquid solution comprising water.

13. The apparatus of claim 1, the liquid solution comprising Copper (II) hydroxide (chemical formula Cu(OH)₂).

14. The apparatus of claim 1, the first probe and/or second probe adapted to receive an electrical current to reduce electrical corrosion.

15. A probe for resistivity measurement, comprising:
a. a conductive shell;
b. a porous insert within the conductive shell, the porous insert adapted to retain a liquid solution; and
c. a contact within the porous insert,
the probe adapted to introduce and/or receive electrical energy from a sample.

16. The probe of claim 15, the conductive shell made of a highly conductive metal.

17. The probe of claim 16, the highly conductive metal comprising copper, silver, brass, stainless steel, or combinations or alloys thereof.

18. The probe of claim 15, the porous insert comprising a fine channeled material capable of liquid fill.

19. The probe of claim 15, the porous insert comprising wood.

20. The probe of claim 19, the wood comprising a hardwood, oak, or pine.

21. The probe of claim 15, the contact comprising a highly conductive material.

22. The probe of claim 21, the highly conductive material comprising brass, copper, or combinations or alloys thereof.
